(19) United States
(12) Patent Application Publication
(10) Pub. No.: US 2018/0240335 A1
(43) Pub. Date: Aug. 23, 2018

(54) ANALYZING VEHICLE SENSOR DATA

(71) Applicant: INTERNATIONAL BUSINESS MACHINES CORPORATION, Armonk, NY (US)

(72) Inventors: WEI SHAN DONG, BEIJING (CN); PENG GAO, BEIJING (CN); CHANG SHENG LI, BEIJING (CN); CHUN YANG MA, BEIJING (CN); FAN WEI, BEIJING (CN); RENJIE YAO, BEIJING (CN)

(21) Appl. No.: 15/436,170

(22) Filed: Feb. 17, 2017

(51) Int. Cl. G08G 1/01; G08G 1/056; G08G 1/00

(52) U.S. Cl. CPC G08G 1/0125; G08G 1/20; G08G 1/056; G08G 1/0112

(57) ABSTRACT

A method according to the present invention includes receiving first vehicle sensor data. The first vehicle sensor data includes first location data and first camera data. The first vehicle sensor data is joined with an existing data cluster of second vehicle sensor data corresponding to additional vehicles. The second vehicle sensor data includes second location data and second camera data. A vehicle heading sequence of the first vehicle is determined, and additional vehicle heading sequences of the additional vehicles based on the second vehicle sensor data is determined. A positional relationship between the vehicle heading sequence of the first vehicle and a target object, and additional positional relationships between each of the additional vehicle heading sequences and the target object are determined. The existing data cluster is split into a plurality of data sub-clusters based on similarities between the positional relationship and the additional positional relationships.

### BACKGROUND

The present invention generally relates to sensor data, and more particularly, to analyzing vehicle sensor data.

Connected car platform and driver assistance systems (DAS) are becoming a useful technology in the automotive industry. For example, DAS solutions may have the capability of collecting moving car probe/sensor (e.g. camera captured) data in real-time. Data collected from a moving car/probe sensor may include discrete samplings and noisy observations of road events. Data analysis may be performed relatively quickly to provide high quality telemetric services, e.g., HPM (Highly Precise Map), to support DAS and autonomous driving.

In addition to car/probe sensor data being relatively noisy, GPS data may be relatively inaccurate in determining a location of a vehicle. Additionally, multiple traffic or other road events may occur simultaneously at a same location, which can lead to sensor errors in detecting road or traffic conditions. For example, road hazards or traffic signs may be incorrectly detected or not detected at all by vehicle probes or sensors. Further, vehicle probes or sensors may detect road hazards or traffic signs that are relatively close to the vehicle, but that are not relevant to the vehicle's actual path of travel (e.g., traffic signs on an opposite side of the road may be detected that are only relevant to vehicles traveling in the opposite direction from a driver's actual path of travel).

### SUMMARY

A computer-implemented method according to an exemplary embodiment of the present invention includes receiving first vehicle sensor data corresponding to a first vehicle. The first vehicle sensor data includes first location data and first camera data. The first vehicle sensor data is joined with an existing data cluster of second vehicle sensor data corresponding to additional vehicles. The second vehicle sensor data includes second location data and second camera data. A vehicle heading sequence of the first vehicle is determined based on the first vehicle sensor data, and additional vehicle heading sequences of the additional vehicles is determined based on the second vehicle sensor data. A positional relationship between the vehicle heading sequence of the first vehicle and a target object, and additional positional relationships between each of the additional vehicle heading sequences and the target object are determined. The target object is included in the first camera data and the second camera data. The existing data cluster is split into a plurality of data sub-clusters based on similarities between the positional relationship and the additional positional relationships.

A system according to an exemplary embodiment of the present invention includes a memory storing a computer program. A network adapter is operatively coupled to the memory. The network adapter receives first vehicle sensor data corresponding to a first vehicle. The first vehicle sensor data includes first location data and first camera data. A processor executes the computer program. The computer program joins the first vehicle sensor data with an existing data cluster of second vehicle sensor data corresponding to additional vehicles. The second vehicle sensor data includes second location data and second camera data. The computer program determines a vehicle heading sequence of the first vehicle based on the first vehicle sensor data, and additional vehicle heading sequences of the additional vehicles based on the second vehicle sensor data. The computer program determines a positional relationship between the vehicle heading sequence of the first vehicle and a target object, and additional positional relationships between each of the additional vehicle heading sequences and the target object. The target object is included in the first camera data and the second camera data. The computer program splits the existing data cluster into a plurality of data sub-clusters based on similarities between the positional relationship and the additional positional relationships.

A computer program product according to an exemplary embodiment of the present invention includes a computer readable storage medium having program instructions embodied therewith. The program instructions are executable by a processor to cause the processor to join first vehicle sensor data with an existing data cluster of second vehicle sensor data. The first vehicle sensor data corresponds to a first vehicle and includes first location data and first camera data, and the second vehicle sensor data corresponds to additional vehicles and includes second location data and second camera data. The program instructions are executable by the processor to cause the processor to determine a vehicle heading sequence of the first vehicle based on the first vehicle sensor data, and additional vehicle heading sequences of the additional vehicles based on the second vehicle sensor data. The program instructions are executable by a processor to cause the processor to determine a positional relationship between the vehicle heading sequence of the first vehicle and a target object, and additional positional relationships between each of the additional vehicle heading sequences and the target object. The target object is included in the first camera data and the second camera data. The program instructions are executable by a processor to cause the processor to split the existing data cluster into a plurality of data sub-clusters based on similarities between the positional relationship and the additional positional relationships.

### BRIEF DESCRIPTION OF THE DRAWINGS

The above and other features of the present invention will become more apparent by describing in detail exemplary embodiments thereof, with reference to the accompanying drawings, in which:

FIG. 1 illustrates a method according to an exemplary embodiment of the present invention.

FIG. 2 illustrates a block diagram of a system according to one or more exemplary embodiments of the present invention.

FIG. 3 illustrates geospatial and topology distance measurements according to one or more exemplary embodiments of the present invention.

FIG. 4 illustrates groups of vehicles, which generate vehicle sensor data that is stored in data clusters, traveling on a road, according to one or more exemplary embodiments of the present invention.

FIG. 5 illustrates a block diagram showing data cluster analysis according to one or more exemplary embodiments of the present invention.

FIG. 6 illustrates a block diagram showing data cluster merging and/or deletion according to one or more exemplary embodiments of the present invention.

FIG. 7 illustrates a method of determining a trajectory pattern of a vehicle based on a vehicle heading sequence according to one or more exemplary embodiments of the present invention.

FIG. 8 illustrates a method of determining a trajectory of a vehicle according to one or more exemplary embodiments of the present invention.

FIG. 9 illustrates an example of a system according to one or more exemplary embodiments of the present invention.

### DETAILED DESCRIPTION

It will be understood that the terms “first,” “second,” “third,” etc. are used herein to distinguish one element from another, and the elements are not limited by these terms. Thus, a “first” element in an exemplary embodiment may be described as a “second” element in another exemplary embodiment.

Exemplary embodiments of the present invention will be described more fully hereinafter with reference to the accompanying drawings. Like reference numerals may refer to like elements throughout the specification and drawings.

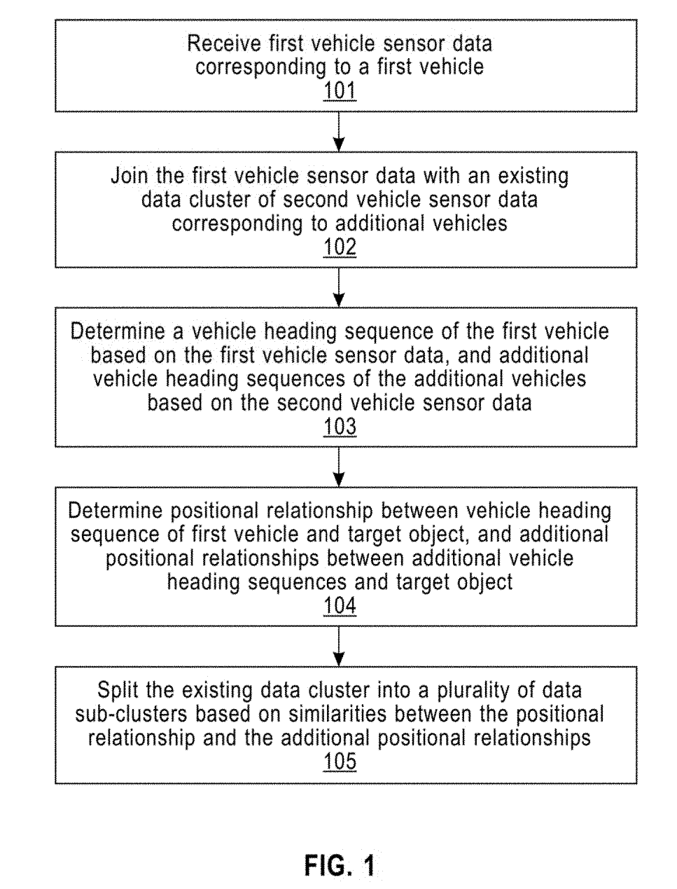

FIG. 1 illustrates a method according to an exemplary embodiment of the present invention.

Referring to FIG. 1, a method (e.g., a computer-implemented method) according to an exemplary embodiment of the present invention includes receiving first vehicle sensor data corresponding to a first vehicle (Step 101). The first vehicle sensor data includes first location data and first camera data. The first vehicle sensor data is joined with an existing data cluster of second vehicle sensor data corresponding to additional vehicles (Step 102). For example, the second vehicle sensor data corresponds to vehicle sensor data previously received from all vehicles other than the first vehicle. The second vehicle sensor data includes second location data and second camera data (e.g., location data and camera data previously received from all vehicles other than the first vehicle). A vehicle heading sequence of the first vehicle is determined based on the first vehicle sensor data, and additional vehicle heading sequences of the additional vehicles are determined based on the second vehicle sensor data (Step 103). A positional relationship between the vehicle heading sequence of the first vehicle and a target object, and additional positional relationships between each of the additional vehicle heading sequences and the target object are determined (Step 104). The target object is included in the first camera data and the second camera data. For example, as vehicles drive near a target object (e.g., a traffic sign), the vehicles may have different vehicle heading sequences as they approach and pass the target object. A vehicle heading sequence refers to a plurality of directions that a front of a vehicle is facing while the vehicle is traveling. The positional relationships between the vehicle heading sequences of the multiple vehicles within the existing data cluster with relation to the same target object may be used to further group the vehicles into sub-clusters. Thus, the existing data cluster is split into a plurality of data sub-clusters based on similarities between the positional relationship and the additional positional relationships (Step 105).

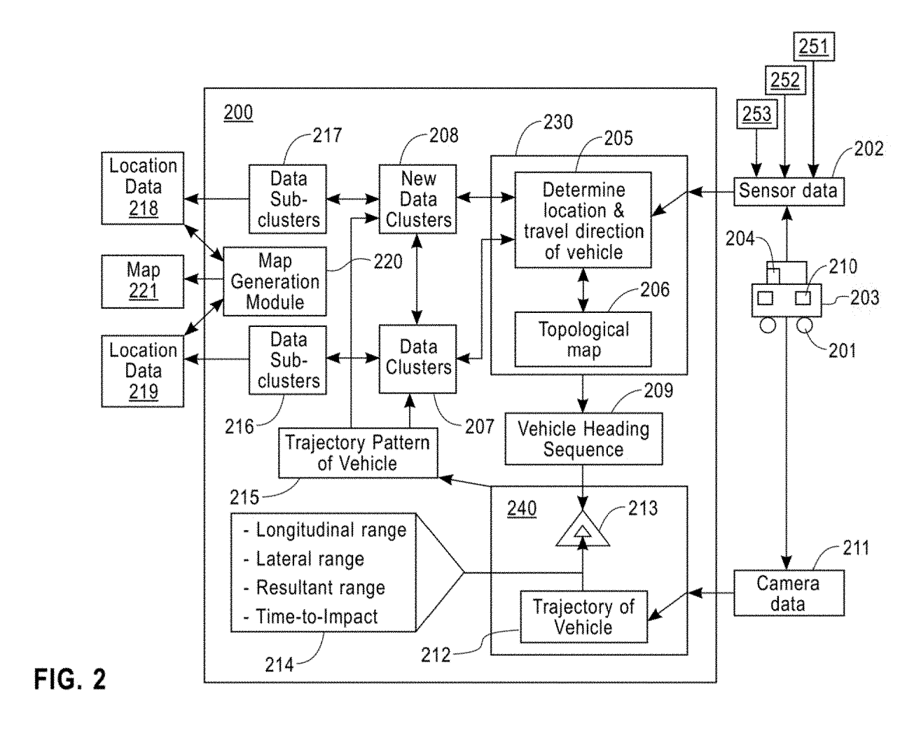

FIG. 2 illustrates a block diagram of a system according to one or more exemplary embodiments of the present invention.

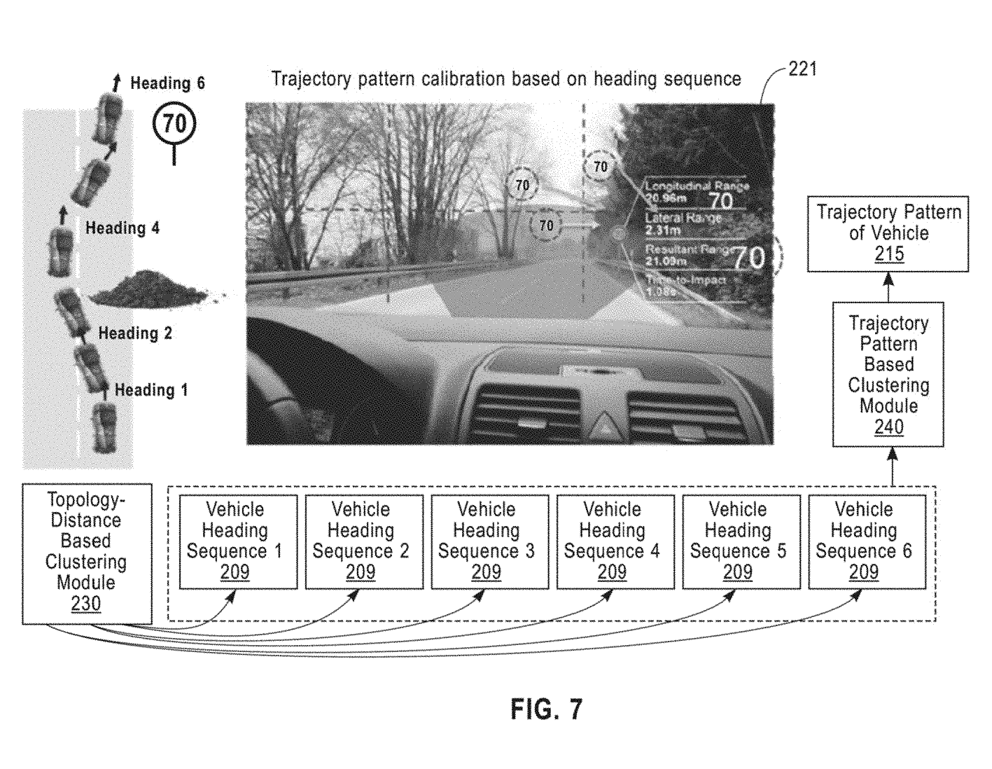

Referring to FIG. 2, in an exemplary system 200, a vehicle 201 may transmit sensor data 202 (e.g., location data, such as GPS data from GPS module 203, and/or camera data 211) to a topology-distance based clustering module 230, and the topology-distance based clustering module 230 may receive the sensor data 202. The location and a travel direction of the vehicle on a topological map 206 are determined using the location data (e.g., the GPS data). The topology-distance based clustering module 230 may access the topological map 206 stored in the topology-distance based clustering module 230 to determine the location and travel direction of the vehicle 205 (e.g., vehicle 201). The sensor data 202 is joined with an existing data cluster 207 of existing sensor data. For example, first vehicle sensor data (e.g., obtained at block 205) may be joined with an existing data cluster 207, which may include second vehicle sensor data corresponding to additional vehicles. Alternatively, a new data cluster 208 including the sensor data is created, using the location and the travel direction of the vehicle 201. A vehicle heading sequence 209 of the vehicle 201 is generated that indicates a plurality of directions that a front of the vehicle 201 is facing while the vehicle 201 is traveling. The generation of a vehicle heading sequence 209 is discussed in more detail below with reference to FIG. 7.

According to an exemplary embodiment of the present invention, the location and travel direction of vehicle 201 on the topological map 206 may be determined by matching the location data (e.g., GPS data generated by the GPS module 203) to corresponding road segments of the topological map 206.

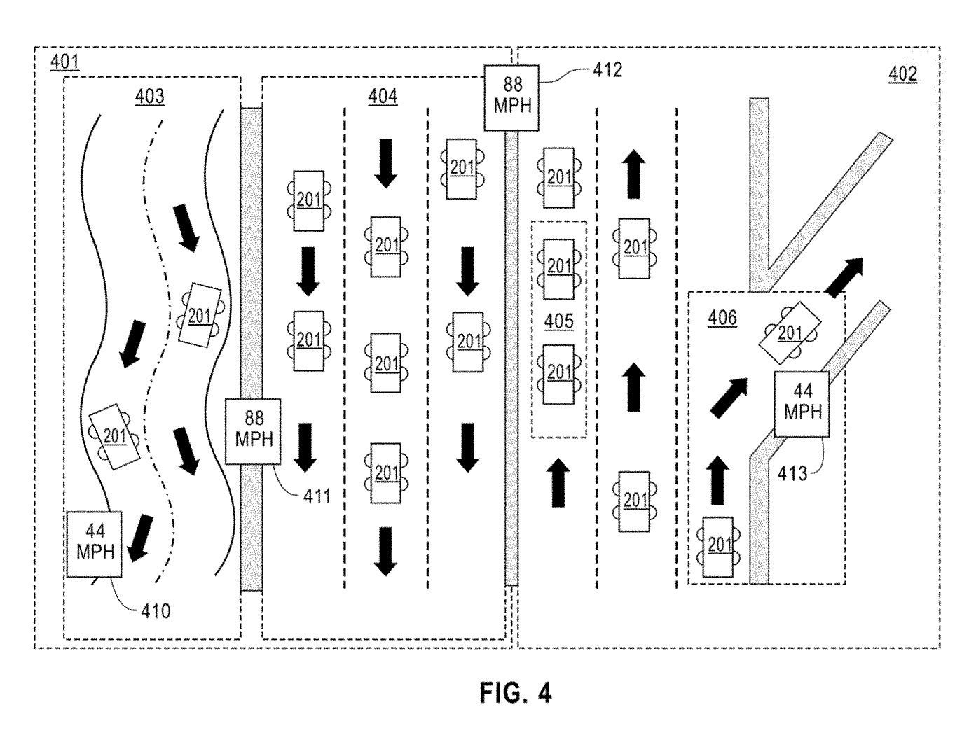

According to an exemplary embodiment of the present invention, a data cluster may refer to sensor data of one or more vehicles from a group of vehicles having a particular general location and direction of travel (see, e.g., data clusters and data sub-clusters described below in more detail with reference to FIG. 4). For example, a data cluster may include a group of vehicles within a particular distance range and traveling in a particular direction on a particular portion of a roadway. For example, a data cluster may include sensor data from substantially all vehicles traveling northbound on an east side of a highway within 500 meters of a particular speed limit sign. When a location and travel direction of a vehicle is determined 205, the location and travel direction of the vehicle may be compared with the location and travel direction of additional vehicles stored in existing data clusters 207. If a match is found between the vehicle's location and travel direction and the location and travel direction of one or more of the data clusters 207, then the sensor data for the vehicle is merged with the matched data cluster 207. Matching/merging sensor data with an existing data cluster 207 may be an indication that a particular vehicle is traveling along a substantially identical path to the one or more vehicles having provided sensor data to the matched/merged data cluster. If no matching data clusters are found, then a new data cluster 208 may be generated. The new data cluster 208 will include sensor data for a new vehicle or group of vehicles within a particular distance range and traveling in a particular direction on a particular portion of a roadway.

According to an exemplary embodiment of the present invention, a new data cluster 208 might be generated when a new traffic pattern is generated on a particular portion of a roadway. For example, a traffic accident or road hazard may occur at a particular point in time, which might result in traffic being diverted onto a shoulder of the road. Thus, a detour or a new traffic pattern might generate sensor data indicating a location and travel direction of a vehicle that had not previously been detected. Therefore, the sensor data would not correspond with sensor data included in any existing data clusters 207, and a new data cluster 208 might be generated. The terms “cluster” and “data cluster” may be used interchangeably herein. The terms “sub-cluster” and “data sub-cluster” may be used interchangeably herein. Clusters and sub-clusters are discussed in more detail below with reference to FIGS. 4-6.

According to an exemplary embodiment of the present invention, a trajectory pattern of the vehicle 215 detected by a camera 204 in the vehicle 201 is generated by determining a trajectory of the vehicle 212 with the vehicle heading sequence 209. The existing data cluster 207 or the new data cluster 208 is split into a plurality of data sub-clusters (see, data sub-clusters 216 and 217, respectively) based on a similarity of the vehicle heading sequence 209 and a plurality of existing vehicle heading sequences included in the existing data cluster 207 or the new data cluster 208. Location information (e.g., location data 218 related to a new data cluster 208 and location data 219 related to an existing data cluster 207) is generated using the data sub-clusters. For example, location information may indicate a location of a target object (see, e.g., target objects 410, 411, 412 and 413 illustrated in FIG. 4), and content information (e.g., a type of target object, such as a speed limit sign or a mile marker). By way of further example, the type of target object may be a particular type of traffic sign and the location information may also include more specific information about the particular type of traffic sign. For example, the target type may be a “speed limit sign” and the more specific information may be a stated maximum speed (e.g., maximum speed of 88 MPH). The terms “location data” and “location information” may be used interchangeably herein.

According to an exemplary embodiment of the present invention, a trajectory pattern based clustering module 240 including a calibration module 213 may determine and/or calibrate the trajectory pattern of the vehicle 215. The trajectory pattern based clustering module 240 may receive camera data 211 from the vehicle 201. The calibration module 213 may combine the trajectory of the vehicle 212 with the vehicle heading sequence 209. The trajectory of the vehicle 212 may include data set 214, which may include longitudinal range, lateral range, resultant range and time-to-impact provided. The data set 214 may be included in the camera data 211. Thus, the location information (e.g., location data 218 related to a new data cluster 208 and location data 219 related to an existing data cluster 207) may include longitudinal range, lateral range, resultant range and time-to-impact with the target object with respect of the path of the vehicle (e.g., vehicle heading sequence 209). Location information of the target object with respect to vehicle heading sequence 209 is discussed in more detail below with reference to FIG. 7.

According to an exemplary embodiment of the present invention, the trajectory pattern of the vehicle 215 may indicate at least one of a longitudinal range of the target object relative to the vehicle 201, a lateral range of the target object relative to the vehicle 201, and a resultant range of the target object relative to the vehicle 201, and a time value indicating an amount of time estimated for the vehicle 201 to reach the target object from its current location in the trajectory pattern.

According to an exemplary embodiment of the present invention, the trajectory of the vehicle 212 may refer to the relative position of the target object with respect to images captured by the camera 204 in the vehicle 201. That is, the trajectory of the vehicle 212 may refer to the relative position of the target object with respect to images captured by the camera 204 in the vehicle 201 at a particular point in time. The trajectory pattern of the vehicle 215 may refer to the relative position of the target object with respect to the path of the vehicle 201. The path of the vehicle may include the vehicle heading sequence 209. The vehicle heading sequence 209 is discussed in more detail below with reference to FIG. 7.

According to an exemplary embodiment of the present invention, the vehicle heading sequence 209 may be generated using at least one of dead-reckoning data (e.g., from dead-reckoning module 251), gyroscope data (e.g., form gyroscope module 252), and/or compass data (see, e.g., compass 253). In some embodiments, one or more of the aforementioned data elements may be obtained by way of a navigation system (e.g., GPS module 203) in vehicle 201.

According to an exemplary embodiment of the present invention, determining the vehicle heading sequence 209 may include a process of calculating a vehicle's current position by using a previously determined position, or fix, and advancing that position based upon known or estimated speeds over elapsed time and course. Dead-reckoning may refer to a process of estimating the value of any variable quantity by using an earlier value and adding whatever changes have occurred in the meantime.

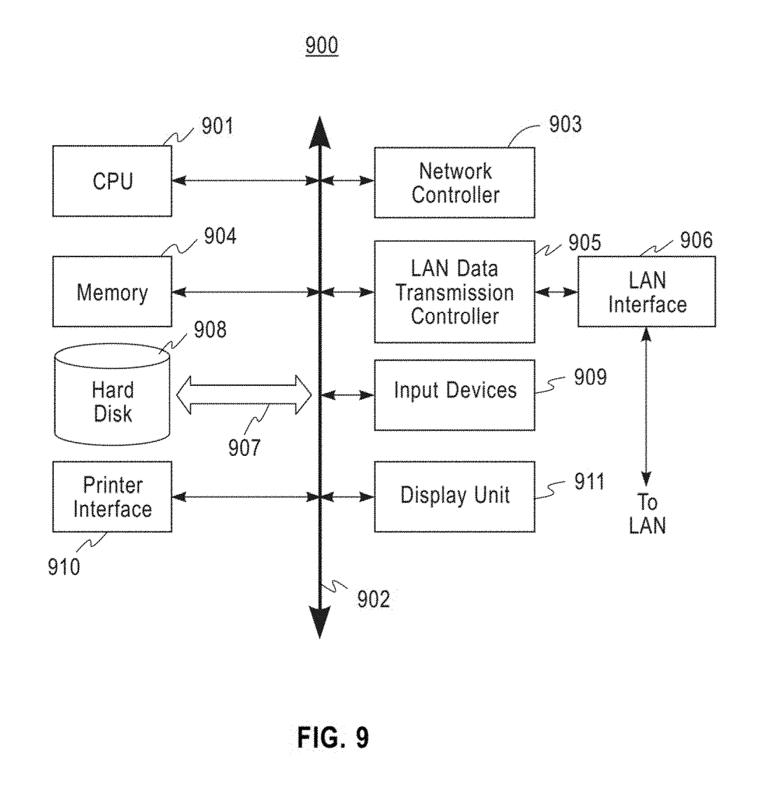

Referring again to FIG. 2, system 200 may include the global positioning system (GPS) module 203 disposed in the vehicle 201. A camera 204 is disposed in the vehicle 201. A network adapter 210 is disposed in the vehicle 201. A computer (see, e.g., computer system 900, discussed in more detail below with reference to FIG. 9) may be located remotely from the vehicle 201. The computer includes a memory storing a computer program, and a processor that executes the computer program (see, e.g., computer system 900, discussed in more detail below with reference to FIG. 9). The computer program determines a location and a travel direction 205 of the vehicle 201 on a topological map 206 using location data (e.g., GPS data) included in sensor data 202 received from the vehicle 201 via the network adapter 210. The computer program joins the sensor data 202 with an existing data cluster 207 of existing sensor data, or creates a new data cluster 208 including the sensor data, using the location and the travel direction of the vehicle 205. The computer program generates a vehicle heading sequence 209 of the vehicle 201 that indicates a plurality of directions that a front of the vehicle is facing while the vehicle is traveling. The computer program generates a trajectory pattern of the vehicle 215 detected by the camera 204 by calibrating a trajectory of the vehicle 212 with the vehicle heading sequence 209 (e.g., discussed below in more detail with reference to FIG. 7). The computer program splits the existing data cluster 207 or the new data cluster 208 into a plurality of data sub-clusters (e.g., 216, 217) based on a similarity of the vehicle heading sequence and a plurality of existing vehicle heading sequences included in the existing data cluster 207 or the new data cluster 208. The computer program generates location data (e.g., location data 218 related to a new data cluster 208 and location data 219 related to an existing data cluster 207) indicating one or more of a location of the target object and a type (e.g., a speed limit sign or a mile marker) and/or content information (e.g., the posted speed limit or a mileage indicated on a mile marker) about the target object, using the data sub-clusters.

The computer program may be stored in a memory of a computer that is remote from the vehicle 201; however exemplary embodiments of the present invention are not limited thereto. For example, the computer program according to one or more exemplary embodiments of the present invention may be stored locally on a memory of a computer disposed in the vehicle 201. That is, the system and method according to exemplary embodiments of the present invention described herein may be embodied in the vehicle 201 and might not employ the network adapter 210 to communicate with a remote computer system. Thus, the method according to exemplary embodiments of the present invention may be executed entirely within the vehicle 201, without the need for a network or Internet connection.

According to an exemplary embodiment of the present invention, the computer program according to one or more exemplary embodiments of the present invention may be stored in the cloud and may be accessed by the vehicle 201. That is, the system and method according to exemplary embodiments of the present invention described herein may be embodied in the cloud and may be accessed using the network adapter 210. Thus, the method according to exemplary embodiments of the present invention may be executed in the cloud.

Referring to FIGS. 2 and 7, according to an exemplary embodiment of the present invention, a map 221 may be generated using location data (e.g., location data 218 or 219) indicating a location of the target object and content information indicating a type of target object. As an example, a location and a type of the target object (e.g., a speed limit sign) may be added to an existing map. The map 221 may be generated by a map generation module 220 (see, e.g., map 221 illustrated in FIG. 7). The map 221 may include the longitudinal range, lateral range, resultant range and time-to-impact. The target object type may be a traffic sign suspended above a roadway or on a side of the roadway. Thus, the vehicle 201 would likely pass the target object, rather than impacting it. Longitudinal range may refer to the distance between the front of the vehicle 201 and a point at which the vehicle 201 will pass the target object. Lateral range may refer to a distance between a side of the vehicle 201 and a side of the target object facing the vehicle 201 when the vehicle 201 passes the target object. The resultant range may refer to a distance between the vehicle 201 and the target object in a straight line. Time to impact may refer to an amount of time, based on the vehicle heading sequence 209, until the front of the vehicle 201 will pass an imaginary line extending from the side of the target object (i.e., until the vehicle 201 passes the target object). The camera 204 may obtain senor data regarding the target object along the line of the resultant range.

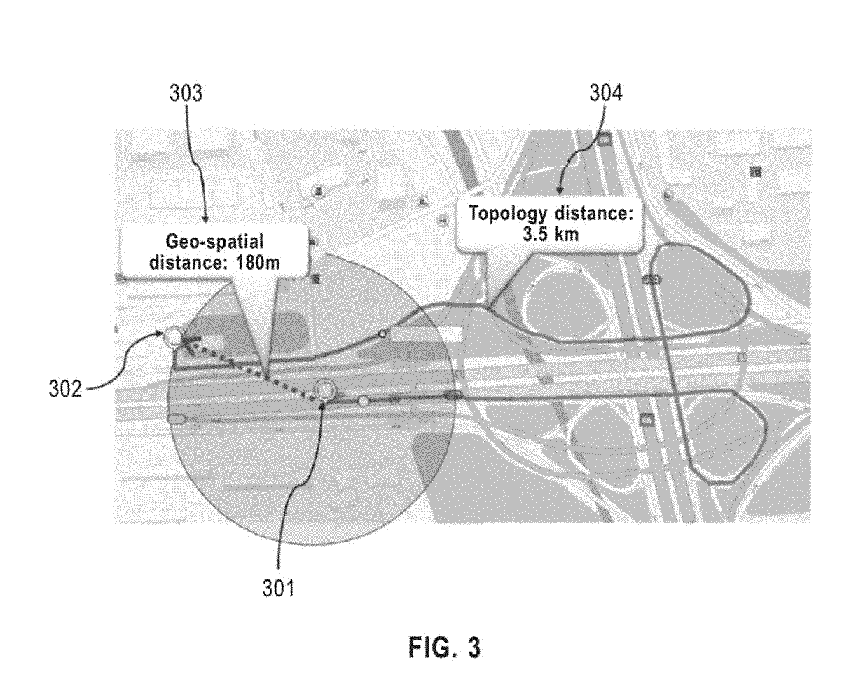

FIG. 3 illustrates geospatial and topology distance measurements according to one or more exemplary embodiments of the present invention.

Referring now to FIG. 3, a geo-spatial distance 303 and/or a topology distance 304 may be determined between a vehicle's location 301 and a target object 302. The target object 302 may be a road hazard or a road event. For example, the target object 302 may include a construction zone or a traffic accident.

According to an exemplary embodiment of the present invention, the sensor data 202 includes location data (e.g., GPS data). A location and a travel direction of the vehicle on a topological map is determined using the location data. For example, the geo-spatial distance 303 and/or the topology distance 304 may be determined between a vehicle's location 301 and a target object 302. The geo-spatial distance 303 may be a distance in a straight line between the vehicle and the target object. The topology distance 304 may be a distance of travel along one or more roadways between the vehicle's location 301 and the target object 302. For example, the topology distance 304 may be a shortest driving route between the vehicle's location 301 and the target object 302.

FIG. 4 illustrates groups of vehicles, which generate vehicle sensor data that is stored in data clusters, traveling on a road, according to one or more exemplary embodiments of the present invention.

Referring now to FIGS. 2 and 4, the sensor data 202 is joined with an existing data cluster 207 of existing sensor data, or a new data cluster 208 including the sensor data is created, using the location and the travel direction of the vehicle 205. A data cluster (e.g., data cluster 401 or data cluster 402) may include sensor data 202 for vehicles 201 traveling in a same direction and in a same general area on a roadway. The sensor data 202 for vehicles 201 with a particular vehicle heading sequence 209 may be further split from the data cluster into one or more data sub-clusters (e.g., data sub-cluster 403, data sub-cluster 404, data sub-cluster 405, or data sub-cluster 406). That is, a data sub-cluster may include sensor data 202 for vehicles 201 occupying a relatively smaller area and may include sensor data 202 for a relatively smaller number of vehicles 201 than a data cluster. For example, sensor data from two vehicles 201 may be grouped into a single data cluster, but different data sub-clusters. Examples of data clusters and data sub-clusters, including sensor data from one or more vehicles contributing data to a respective data cluster or data sub-cluster, are discussed below in more detail.

According to an exemplary embodiment of the present invention, each data cluster or data sub-cluster may include sensor data 202 received from multiple vehicles 201 having traveled along a substantially similar vehicle heading sequence 209. For example, the multiple vehicles 201 may each travel along a single stretch of highway, or in a single lane of a roadway.

### EXAMPLE I

Sensor data (e.g., sensor data 202) for a plurality of vehicles 201 in a first group of vehicles 401 may be included in a first data cluster. The plurality of vehicles 201 in the first group of vehicles 401 may all be traveling in or may have previously traveled in a same general direction and may all be in or may have previously been in a same general geographic area. However, the first group of vehicles 401 may include vehicles traveling on more than one roadway, and therefore different target objects (e.g., traffic signs) may be relevant to a particular subset of the plurality of vehicles 201 included in the first group of vehicles 401. The sensor data for the plurality of vehicles 201 in the first group of vehicles 401 may be split into two data sub-clusters. A first data sub-cluster may include sensor data from a first group of vehicles 403, and a second data sub-cluster may include sensor data from a second group of vehicles 404. The first data sub-cluster may include sensor data for vehicles 201 for which a first speed limit sign 410 is relevant, while the second data sub-cluster may include sensor data for vehicles 201 for which a second speed limit sign 411 is relevant. Thus, sensor data from a vehicle 201 that is currently traveling may be matched with a particular data cluster and a particular data sub-cluster to more accurately determine a location and travel direction of a vehicle 201 that is currently traveling. Thus, splitting of the first data cluster into two data sub-clusters allows identification of relevant target objects.

### EXAMPLE II

Sensor data (e.g., sensor data 202) for a plurality of vehicles 201 in a second group of vehicles 402 may be included in a second data cluster. The plurality of vehicles 201 in the second group of vehicles 402 may all be traveling in or may have previously traveled in a same general direction and may all be in or may have previously been in a same general geographic area. However, the second group of vehicles 402 may include vehicles traveling on a highway and vehicles traveling onto an exit ramp exiting the highway, and therefore different traffic signs may be relevant to a particular subset of the plurality of vehicles 201 included in the second group of vehicles 402. The sensor data for the plurality of vehicles 201 included in the second group of vehicles 402 may be split into two data sub-clusters. A first data sub-cluster may include sensor data from a first group of vehicles 405, and a second data sub-cluster may include sensor data from a second group of vehicles 406. The first data sub-cluster may include sensor data for vehicles 201 for which a first speed limit sign 412 is relevant (i.e., vehicles not exiting the highway), while the second data sub-cluster may include sensor data for vehicles 201 for which a second speed limit sign 413 is relevant (i.e., vehicles exiting the highway). Thus, sensor data from a vehicle 201 that is currently traveling may be matched with a particular data cluster and a particular data sub-cluster to more accurately determine a location and travel direction of a vehicle 201 that is currently traveling. Thus, splitting of the first data cluster into two data sub-clusters allows identification of relevant target objects.

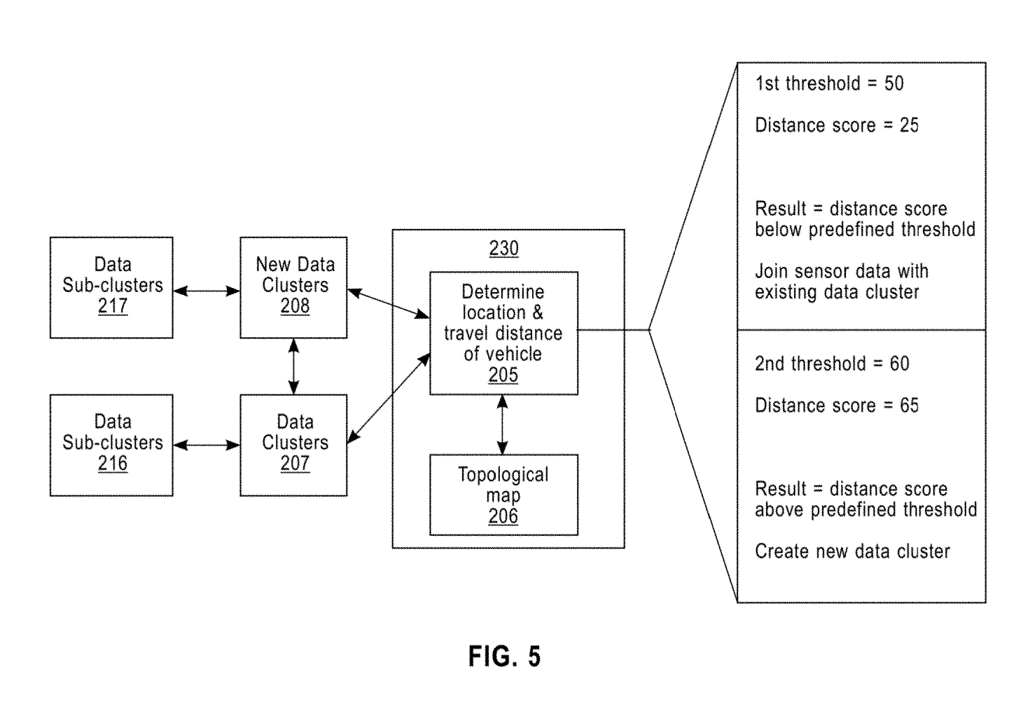

FIG. 5 illustrates a block diagram showing data cluster analysis according to one or more exemplary embodiments of the present invention.

Referring now to FIGS. 2 and 5, a first threshold (e.g. a value set on a scale of 0-100) may be set and a distance score may be calculated between a location and travel direction of a first vehicle on a topological map 206 and a location and travel direction of second vehicles contributing sensor data to a data cluster 207 and/or data sub-cluster 216. If the distance score is below the first threshold, indicating that a location and travel direction of the first vehicle is substantially similar to that of the second vehicles contributing sensor data to the data cluster 207 and/or data sub-cluster 216, then the sensor data of the first vehicle may be joined with the data cluster 207 and/or data sub-cluster 216. Alternatively, if the distance score is above the first threshold, then a new data cluster may be created.

As an example, if a sufficiently similar vehicle heading sequence 209 of a first vehicle compared with a vehicle heading sequence of second vehicles contributing sensor data to an existing data cluster 207 is found then the sensor data of the first vehicle may be joined with the existing data cluster 207. For example, if the first vehicle's location on the topological map 206 based on the first vehicle's vehicle heading sequence 209 is less than 50 meters from the second vehicle's location on the topological map 206 based on the second vehicle's vehicle heading sequence 209 (i.e., the second vehicles contributing sensor data to the existing data cluster 207 and/or data sub-cluster 216), then the sensor data of the first vehicle may be joined with the existing data cluster 207. However, exemplary embodiments of the present invention are not limited to any particular distance between first and second vehicles. Thus, threshold values, as described herein, may be set, as desired.

According to an exemplary embodiment of the present invention, vehicle positions on the topological map 206 may similarly be applied to joining sensor data with data sub-clusters (e.g., 216 and/or 217). Thus, each data sub-cluster may include sensor data from vehicles having substantially similar vehicle heading sequences from each other.

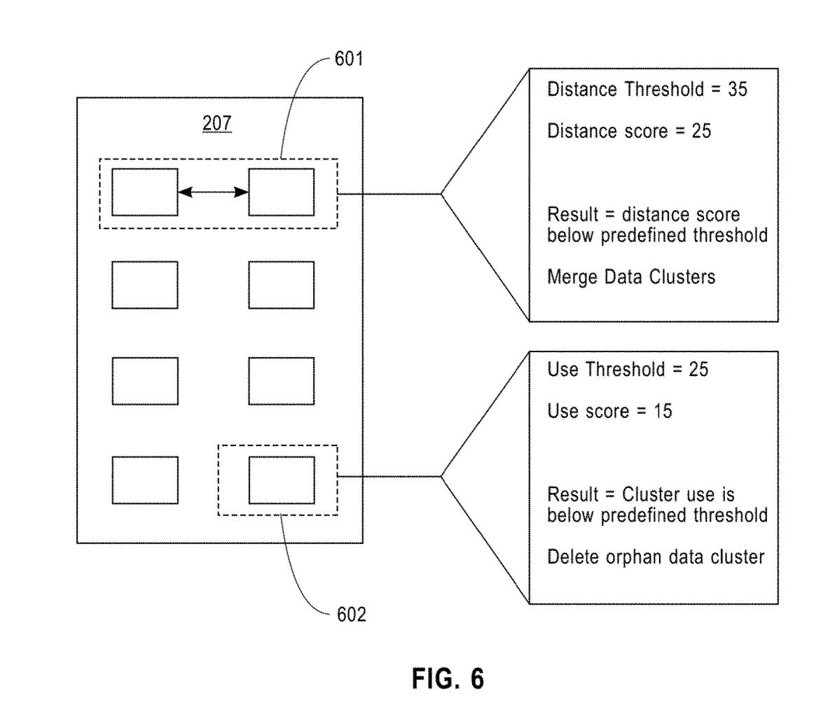

FIG. 6 illustrates a block diagram showing data cluster merging and/or deletion according to one or more exemplary embodiments of the present invention.

Referring to FIGS. 2 and 6, according to an exemplary embodiment of the present invention, two existing data clusters may be merged with one another when a distance between the at least two existing data clusters is below a predefined distance threshold. For example, an existing data cluster 207 may include a plurality of data clusters, and two or more data clusters of the plurality of data clusters may represent approximately a same location and travel distance on a roadway. Thus, the two or more data clusters of the plurality of data clusters may be merged into a single data cluster.

As an example, a distance threshold may be set at a predetermined value (e.g. a value set on a scale of 0-100). A distance score between at least two data clusters may be determined. If the distance score is below the distance threshold then the at least two data clusters may be merged into single data cluster 601. The threshold value and the distance score and/or use score may each be on a scale of 0-100. According to an exemplary embodiment of the present invention, a similar process may be applied to merge data sub-clusters into a single data sub-cluster.

According to an exemplary embodiment of the present invention, the method may include deleting at least one existing data cluster.

For example, a data cluster may be generated as a result of a detour on a roadway and the data cluster may be matched with new sensor data for the period of time while the detour is present. When the detour is removed, the traffic pattern on the roadway may return to normal and the data cluster reflecting the traffic pattern when the detour was present might no longer be matched with (e.g., may no longer match the sensor data of vehicles traversing the normal traffic pattern). Thus, the data cluster reflecting the traffic pattern when the detour is present may become an orphan data cluster. In some embodiments, when use of a data cluster falls below a predetermined use threshold value, the data cluster 602 might be deleted as an orphan. Thus, orphan data clusters which are no longer matched with new sensor data may be deleted after a desired amount of non-use. In some embodiments, the use threshold and use scores may each be on a scale of 0-100. According to some embodiments, a similar process may be applied for deleting data sub-clusters.

According to an exemplary embodiment of the present invention, the method may include merging data clusters. For example, each of multiple data clusters may have a location and a direction, which may be an average of all the location and direction data belonging to a particular data cluster. Merging two data clusters may be done by first determining a degree of similarity between two data clusters. The similarity definition may be substantially the same as similarity between a data record and a data cluster. If two individual data clusters are sufficiently similar, then a new data cluster containing all the data records from the two data clusters may be formed and the two individual data clusters may be deleted. The newly formed data cluster may be considered a merged data cluster.

According to an exemplary embodiment of the present invention, a data cluster of a particular predetermined age may be deleted. For example, a data cluster updated/created one year ago may already be outdated and may be deleted. In another example, when due to a computer's memory limitation, there is no space for storing new data clusters; the oldest data clusters may be deleted. However, exemplary embodiments of the present invention are not limited to deleting data clusters of a particular age and deletion criteria may be adjusted, as desired.

FIG. 7 illustrates a method of determining a trajectory pattern of a vehicle based on vehicle heading sequence according to one or more exemplary embodiments of the present invention.

Referring now to FIGS. 2 and 7, according to an exemplary embodiment of the present invention, a vehicle heading sequence 209 may be detected by a camera in the vehicle. The vehicle heading sequence 209 may be determined through the use of one or more object tracking algorithms in the computer vision discipline. For example, if a vehicle moves in a straight line, the trajectory of the vehicle in the camera view will also be straight, and if the vehicle moves along a curve, the trajectory of the vehicle in the camera view will also be a curve. Thus, vehicle heading sequence 209 may accurately reflect the vehicle heading change more accurately as it changes direction. The vehicle heading sequence 209 may be obtained from GPS data, but GPS data may be noisy and relatively inaccurate. A calibration may include using a recognized vehicle trajectory pattern from a camera (which may be relatively accurate) together with a vehicle heading sequence extracted from GPS data (which may be relatively noisy & unreliable) to generate a more reliable estimate of the actual vehicle heading sequence. Thus, calibrating a trajectory pattern of a vehicle based on vehicle heading sequence may include fusing multiple vehicle heading sequences into a single trajectory pattern, as discussed below in more detail.

The vehicle heading sequence 209 of a first vehicle among a plurality of vehicles 201 (see, e.g., FIG. 4 illustrating a plurality of vehicles 201) may indicate a plurality of directions that a front of the first vehicle is facing while the first vehicle is traveling. Additional vehicle heading sequences of additional vehicles (e.g., other vehicles of the plurality of vehicles 201 illustrated, for example, in FIG. 4) respectively indicate a plurality of directions that a front of the additional vehicles is facing while the additional vehicles are traveling. Thus, a plurality of directions that a front of the first vehicle is facing while the first vehicle is traveling may refer to a vehicle that is in motion and is therefore following a dynamic trajectory pattern. Raw data of the vehicle heading sequence 209 may be collected by one or more sensors in the vehicle 201 (e.g., 251, 252, 253, 203 and/or 204) and sensor data 202 may be transmitted to a computer and/or system (e.g., by the network adapter 210), as described herein, either substantially instantaneously (e.g., in real-time), or the sensor data 202 may be stored and transmitted at a later time (e.g., if network connectivity is not available). Thus, sensor data 202 may be used to determine a heading sequence of a first vehicle among a plurality of vehicles 201 (see, e.g., FIG. 4 illustrating a plurality of vehicles 201).

According to an exemplary embodiment of the present invention, the vehicle heading sequence 209 may be determined multiple times before determining a trajectory pattern of the vehicle 215. For example, multiple headings may be used to detect a change in an actual path of a vehicle, which may deviate from a path specified in a particular data cluster or data sub-cluster as a result of a detour or a change in traffic pattern. Multiple headings may also be used to generate a vehicle heading sequence covering a relatively larger geographic area than a single vehicle heading sequence.

According to an exemplary embodiment of the present invention, the multiple vehicle heading sequences 209 may be grouped together by the trajectory pattern based clustering module 240, and the grouped vehicle heading sequences 209 may be used to generate the trajectory pattern of the vehicle 215.

According to an exemplary embodiment of the present invention, location data (e.g., location data 218 or 219) and a map 221 may be generated for the target object with respect to the vehicle's heading sequence. The map 221 may include longitudinal range, lateral range, resultant range and time-to-impact with the target object with respect of the path of the vehicle (e.g., vehicle heading sequence 209).

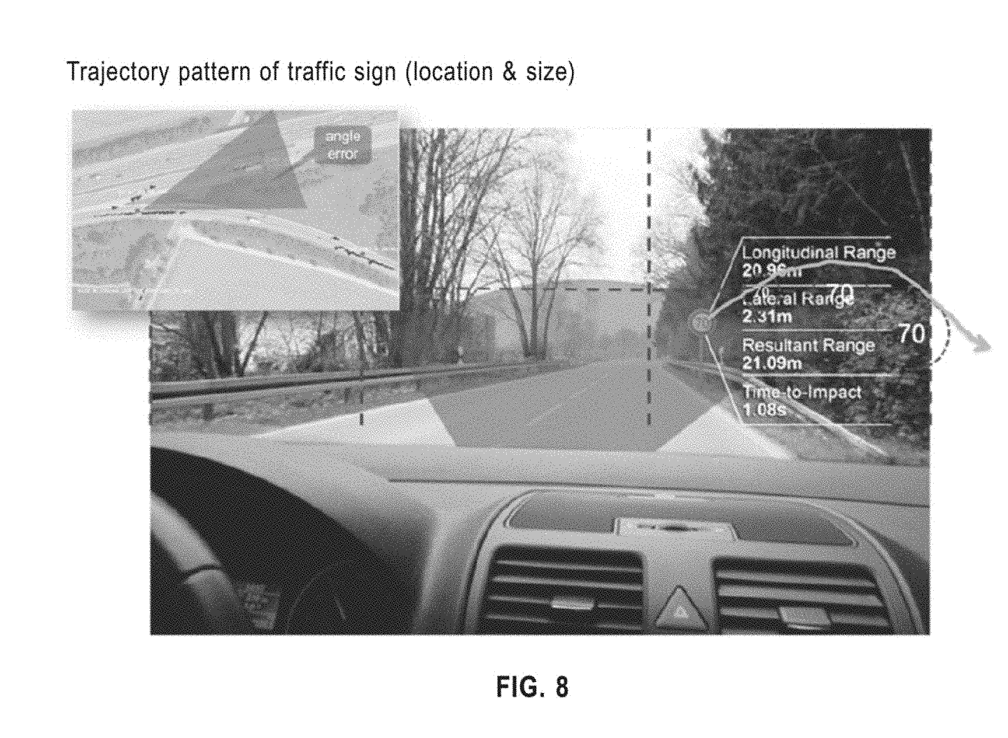

FIG. 8 illustrates a method of determining a trajectory of a vehicle according to one or more exemplary embodiments of the present invention.

Referring now to FIGS. 2 and 8, a vehicle heading sequence 209 of a vehicle 201 with respect to a traffic sign may be determined. The vehicle heading sequence 209 of the vehicle 201 with respect to the traffic sign may include longitudinal range, lateral range, resultant range and time-to-impact with the target object with respect of the path of the vehicle.

Referring to FIG. 8, an angle error may occur if a wrong target object is evaluated. For example, if a vehicle is exiting a highway, then road signs suspended above or on a side of the highway indicating a speed limit on the highway might not be relevant to the vehicle exiting the highway. A road sign indicating a speed limit on the exit ramp for the highway may actually be relevant. Thus, according to exemplary embodiments of the present invention, an irrelevant traffic sign may be ignored, while a relevant traffic sign is evaluated and a trajectory of a vehicle with respect to the traffic sign is determined.

FIG. 9 illustrates an example of a system according to one or more exemplary embodiments of the present invention.

Some exemplary embodiments of the present invention may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

Referring now to FIG. 9, system 900 may include, for example, a central processing unit (CPU) 901, random access memory (RAM) 904, a printer interface 910, a display unit 911, a local area network (LAN) data transmission controller 905, a LAN interface 906, a network controller 903, an internal bus 902, and one or more input devices 909, for example, a keyboard, mouse etc. As shown, the system 900 may be connected to a data storage device, for example, a hard disk, 908 via a link 907.

The descriptions of the various exemplary embodiments of the present invention have been presented for purposes of illustration, but are not intended to be exhaustive or limited to the exemplary embodiments disclosed. Many modifications and variations will be apparent to those of ordinary skill in the art without departing from the scope and spirit of the described exemplary embodiments. The terminology used herein was chosen to best explain the principles of the exemplary embodiments, or to enable others of ordinary skill in the art to understand exemplary embodiments described herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and/or block diagrams in the figures illustrate the architecture, functionality, and operation of possible implementations of systems, methods, and computer program products according to various exemplary embodiments of the invention. In this regard, each block in the flowchart or block diagrams may represent a module, segment, or portion of instructions, which includes one or more executable instructions for implementing the specified logical function(s). In alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

According to an exemplary embodiment of the present invention, a computer program product may include a computer readable storage medium having program instructions embodied therewith. The program instructions are executable by a processor (e.g., CPU 901) to cause the processor to join first vehicle sensor data 202 with an existing data cluster 207 of second vehicle sensor data. The first vehicle sensor data 202 corresponds to a first vehicle (e.g., a vehicle of a plurality of vehicles 201 described in more detail above with reference to FIGS. 2 and 4) and includes first location data and first camera data, and the second vehicle sensor 202 data corresponds to additional vehicles (e.g., additional vehicles of a plurality of vehicles 201 described in more detail above with reference to FIGS. 2 and 4) and includes second location data and second camera data. The first vehicle sensor data 202 corresponds to the first vehicle and includes first location data and first camera data, and the second vehicle sensor data 202 corresponds to additional vehicles and includes second location data and second camera data. The program instructions are executable by a processor to cause the processor to determine a positional relationship between the vehicle heading sequence of the first vehicle 209 and a target object (e.g., a traffic sign, as described in more detail above), and additional positional relationships between each of the additional vehicle heading sequences 209 and the target object. The target object is included in the first camera data and the second camera data. The program instructions are executable by a processor to cause the processor to split the existing data cluster 207 into a plurality of data sub-clusters 216 based on similarities between the positional relationship and the additional positional relationships.

According to an exemplary embodiment of the present invention, a trajectory matching function (see, e.g., trajectory pattern based clustering module 240 illustrated, e.g., in FIG. 2) may be performed by receiving raw GPS data (see, e.g., sensor data 202 including GPS data received from vehicle 201 illustrated, e.g., in FIG. 2) of a location of a vehicle on a topographic map. The trajectory matching function may determine an approximate location of the vehicle on a road network, and a direction of heading of the vehicle (e.g., north or south bound sides of a highway). A heading sequence (see, e.g. FIG. 7) of the vehicle may be determined by using one or more of dead-reckoning data obtained from the dead-reckoning module 251, gyroscope data obtained from the gyroscope 252 or magnetic data obtained from the compass 251. A data fusion function (see, e.g. FIG. 7) may fuse the map matching data, dead-reckoning data, gyroscope data and magnetic data to determine a heading sequence of the vehicle.

According to some embodiments of the present invention, data from multiple sensors may be fused, based on a combination of sensory data or data derived from disparate sources such that the resulting information has less uncertainty than would occur when the sources were used individually. The term uncertainty reduction may refer to more accurate, more complete, or more dependable, or refer to the result of an emerging view, such as stereoscopic vision (e.g., calculation of depth information by combining two-dimensional images from two cameras at slightly different viewpoints). The data sources for a fusion process might not originate from identical sensors. Fusing data from multiple sensors may include direct fusion, indirect fusion and fusion of the outputs of the former two. Direct fusion may refer to the fusion of sensor data from a set of heterogeneous or homogeneous sensors, soft sensors, and history values of sensor data. Indirect fusion may refer to information sources like a priori knowledge about the environment and human input. Sensor fusion is also known as (multi-sensor) data fusion and is a subset of information fusion. Sensor fusion may be defined as the unification of visual excitations from corresponding retinal images into a single visual perception a single visual image. Single vision is a hallmark of retinal correspondence. Double vision is a hallmark of retinal disparity.

The following are exemplary sensor data fusion calculations.

Let x₁ and x₂ denote two sensor measurements with noise variances σ₁² and σ₂², respectively. One way of obtaining a combined measurement x₃ is to apply the Central Limit Theorem, which is also employed within the Fraser-Potter fixed-interval smoother, namely x₃=σ₃²(σ₁⁻²x₁+σ₂⁻²x₂), where σ₃²=(σ₁⁻²+σ₂⁻²)⁻¹ is the variance of the combined estimate. It can be seen that the fused result is a linear combination of the two measurements weighted by their respective noise variances.

Another example method to fuse two measurements is to use the optimal Kalman filter. Suppose that the data is generated by a first-order system and let Pₖ denote the solution of the filter's Riccati equation. By applying Cramer's rule within the gain calculation it can be found that the filter gain is given by:

$${L}_{k} = ⌊ \begin{matrix}\frac{{σ}_{2}^{2} {P}_{k}}{{σ}_{2}^{2} {P}_{k} + {σ}_{1}^{2} {P}_{k} + {σ}_{1}^{2} {σ}_{2}^{2}} & \frac{{σ}_{1}^{2} {P}_{k}}{{σ}_{2}^{2} {P}_{k} + {σ}_{1}^{2} {P}_{k} + {σ}_{1}^{2} {σ}_{2}^{2}}\end{matrix} ⌋ .$$

When the first measurement is noise free, the filter ignores the second measurement and vice versa. That is, the combined estimate may be weighted by the quality of the measurements.

A trajectory pattern of a vehicle with respect to a target object (e.g., traffic sign) may be determined based on a heading sequence of the vehicle. That is, relevant traffic signs may be evaluated, while irrelevant signs are ignored by the system and method according to exemplary embodiments of the present invention described herein.

According to an exemplary embodiment of the present invention, a traffic sign recognition score may be calculated. The traffic sign recognition score may be used to determine the likelihood that a particular type of traffic sign (e.g., hazard sign vs. speed limit sign) has been detected. The traffic sign recognition score may be a score from 0-1, with 1 indicating 100% certainty that a particular type of traffic sign has been detected. A threshold acceptable traffic sign recognition score may be set at a predetermined value (e.g., 90% certainty that a particular type of sign has been detected).

According to an exemplary embodiment of the present invention, map matching of raw GPS data (see, e.g., trajectory pattern based clustering module 240 illustrated, e.g., in FIG. 2) to road segments may include performing map-matching to attached road link identification data records (see, e.g., topological map 206 illustrated, e.g., in FIG. 2) with new GPS data. Topology-distance based clustering may be performed (see, e.g., FIG. 4). Topology-distance based clustering may include calculating directional road distance to find a closest data cluster. Existing data clusters that are highly similar (e.g., according to a predetermined threshold) may be merged into a single data cluster and unused data clusters may be deleted, as discussed in more detail above.

While the present invention has been particularly shown and described with reference to exemplary embodiments thereof, it will be understood by those of ordinary skill in the art that various changes in form and detail may be made therein without departing from the spirit and scope of the present invention as defined by the following claims.

1. A computer-implemented method, comprising:
receiving first vehicle sensor data corresponding to a first vehicle, wherein the first vehicle sensor data comprises first location data and first camera data;
joining the first vehicle sensor data with an existing data cluster of second vehicle sensor data corresponding to additional vehicles, wherein the second vehicle sensor data comprises second location data and second camera data;
determining a vehicle heading sequence of the first vehicle based on the first vehicle sensor data, and additional vehicle heading sequences of the additional vehicles based on the second vehicle sensor data;
determining a positional relationship between the vehicle heading sequence of the first vehicle and a target object, and additional positional relationships between each of the additional vehicle heading sequences and the target object, wherein the target object is included in the first camera data and the second camera data; and
splitting the existing data cluster into a plurality of data sub-clusters based on similarities between the positional relationship and the additional positional relationships.

2. The computer-implemented method of claim 1, wherein the vehicle heading sequence of the first vehicle indicates a plurality of directions that a front of the first vehicle is facing while the first vehicle is traveling, and the additional vehicle heading sequences of the additional vehicles respectively indicate a plurality of directions that a front of the additional vehicles is facing while the additional vehicles are traveling.

3. The computer-implemented method of claim 1, further comprising:
determining a location of the first vehicle and a travel direction of the first vehicle based on the location data,
wherein the first vehicle sensor data is joined with the existing data cluster based on the location and the travel direction.

4. The computer-implemented method of claim 3, wherein determining the location of the first vehicle and the travel direction of the first vehicle comprises matching the first location data to corresponding road segments on a map.

5. The computer-implemented method of claim 1, further comprising:
generating location information indicating a location of the target object, and information indicating a type of the target object, based on the data sub-clusters.

6. The computer-implemented method of claim 5, further comprising:
generating a map based on the location information indicating the location of the target object and the information indicating the type of the target object.

7. The computer-implemented method of claim 5, further comprising:
adding the target object to an existing map, wherein the added target object conveys the location of the target object and the type of the target object on the existing map.

8. The computer-implemented method of claim 1,
wherein the first vehicle sensor data comprises at least one of dead-reckoning data obtained by a navigation system of the first vehicle, gyroscope data obtained by the navigation system, and compass data obtained by the navigation system,
wherein the vehicle heading sequence of the first vehicle is determined using at least one of the dead-reckoning data, the gyroscope data, and the compass data.

9. The computer-implemented method of claim 1, wherein each data sub-cluster comprises similar positional relationships.

10. The computer-implemented method of claim 1, wherein the positional relationship between the vehicle heading sequence of the first vehicle and the target object comprises at least one of a longitudinal range of the target object relative to the first vehicle, a lateral range of the target object relative to the first vehicle, and a resultant range of the target object relative to the first vehicle.

11. The computer-implemented method of claim 1, further comprising:
merging the existing data cluster with another existing data cluster when a distance between the existing data cluster and the another existing data cluster is below a predefined threshold.

12. A system, comprising:
a memory storing a computer program;
a network adapter operatively coupled to the memory, wherein the network adapter receives first vehicle sensor data corresponding to a first vehicle, and the first vehicle sensor data comprises first location data and first camera data; and
a processor that executes the computer program, wherein the computer program:
joins the first vehicle sensor data with an existing data cluster of second vehicle sensor data corresponding to additional vehicles, wherein the second vehicle sensor data comprises second location data and second camera data;
determines a vehicle heading sequence of the first vehicle based on the first vehicle sensor data, and additional vehicle heading sequences of the additional vehicles based on the second vehicle sensor data;
determines a positional relationship between the vehicle heading sequence of the first vehicle and a target object, and additional positional relationships between each of the additional vehicle heading sequences and the target object, wherein the target object is included in the first camera data and the second camera data; and
splits the existing data cluster into a plurality of data sub-clusters based on similarities between the positional relationship and the additional positional relationships.

13. The system of claim 12, wherein the vehicle heading sequence of the first vehicle indicates a plurality of directions that a front of the first vehicle is facing while the first vehicle is traveling, and the additional vehicle heading sequences of the additional vehicles respectively indicate a plurality of directions that a front of the additional vehicles is facing while the additional vehicles are traveling.

14. The system of claim 12, wherein the computer program further:
determines a location of the first vehicle and a travel direction of the first vehicle based on the location data,
wherein the first vehicle sensor data is joined with the existing data cluster based on the location and the travel direction.

15. The system of claim 12, wherein the computer program further:
generates location information indicating a location of the target object, and information indicating a type of the target object, based on the data sub-clusters.

16. The system of claim 12, wherein each data sub-cluster comprises similar positional relationships.

17. A computer program product comprising a computer readable storage medium having program instructions embodied therewith, the program instructions executable by a processor to cause the processor to:
join first vehicle sensor data with an existing data cluster of second vehicle sensor data, wherein the first vehicle sensor data corresponds to a first vehicle and comprises first location data and first camera data, and the second vehicle sensor data corresponds to additional vehicles and comprises second location data and second camera data;
determine a vehicle heading sequence of the first vehicle based on the first vehicle sensor data, and additional vehicle heading sequences of the additional vehicles based on the second vehicle sensor data;
determine a positional relationship between the vehicle heading sequence of the first vehicle and a target object, and additional positional relationships between each of the additional vehicle heading sequences and the target object, wherein the target object is included in the first camera data and the second camera data; and
split the existing data cluster into a plurality of data sub-clusters based on similarities between the positional relationship and the additional positional relationships.

18. The computer program product of claim 17, wherein the vehicle heading sequence of the first vehicle indicates a plurality of directions that a front of the first vehicle is facing while the first vehicle is traveling, and the additional vehicle heading sequences of the additional vehicles respectively indicate a plurality of directions that a front of the additional vehicles is facing while the additional vehicles are traveling.

19. The computer program product of claim 17, wherein the program instructions executable by the processor further cause the processor to:
determine a location of the first vehicle and a travel direction of the first vehicle based on the location data,
wherein the first vehicle sensor data is joined with the existing data cluster based on the location and the travel direction.

20. The computer program product of claim 17, wherein the program instructions executable by the processor further cause the processor to:
generate location information indicating a location of the target object, and information indicating a type of the target object, based on the data sub-clusters.
